(19) United States
(12) Patent Application Publication
(10) Pub. No.: US 2013/0043691 A1
(43) Pub. Date: Feb. 21, 2013

(54) ACTUATOR

(71) Applicant: Heiko MARZ, Lubeck (DE)

(72) Inventor: Heiko MARZ, Lubeck (DE)

(21) Appl. No.: 13/586,954

(22) Filed: Aug. 16, 2012

(30) Foreign Application Priority Data
Aug. 18, 2011 (DE) DE 102011111002.3

(51) Int. Cl. A62B 7/14; E05C 1/04; B64D 11/00; F03G 7/06

(52) U.S. Cl. 292/144; 60/528

(57) ABSTRACT

An actuator for opening a locking of an emergency oxygen container or a mask door in an aircraft. The actuator includes an opener of a shape memory alloy and a resistance wire. The resistance wire is at least partly wound around the opener and can be connected to a supply voltage.

### CROSS REFERENCE TO RELATED APPLICATIONS

This application claims the benefit of priority under 35 U.S.C. §119 of German Patent Application DE 10 2011 111 002.3 filed Aug. 18, 2011, the entire contents of which are incorporated herein by reference.

### FIELD OF THE INVENTION

The invention relates to an actuator, in particular for opening a lock or locking arrangement of an emergency oxygen container or a mask door in an aircraft.

### BACKGROUND OF THE INVENTION

In passenger aircraft, a passenger support unit or passenger service unit PSU, is typically arranged above the seat rows, in which unit, apart from the illumination and ventilation, in particular passenger oxygen masks are also arranged, which in the case of a pressure drop within the cabin, fall downwards, in order to be within reach of the passengers. For this, a compartment or container which is closable by mask door arranged on the lower side and in which typically two four or also more passenger oxygen masks are arranged, depending on the number of seats located therebelow, is provided in the passenger support unit. The masks usually have an emergency oxygen supply tube, via which they are connected to a suitable stationary oxygen connection in the passenger service unit. The stationary oxygen connection is typically connected to an emergency oxygen container.

In the case of requirement, the mask door as well as the emergency oxygen container must be opened, in order to be able to supply the passengers with oxygen. It is known in the state of the art, for these to be able to be opened in an aircraft from a central location, or however to be able to be opened by the passenger himself in a simple manner.

It is also known in the state of the art, to apply components of shape memory alloys as actuators. Thereby, one differentiates between three types of activation. With the first type of activation, the current is led directly through the shape memory alloy. The current heats the shape memory alloy on account of the resistance. Heat can alternatively be fed indirectly. Thereby, an electrical current heats a medium which then heats the shape memory alloy. Moreover, heat can be fed directly from a medium changing the temperature, such as for example with a thermostat in a cooling circuit.

In passenger aircraft, the input variable for opening a locking of the emergency oxygen container or mask door consists of a high alternating voltage. It is counted as belonging to the state of the art, to open such flaps by way of electromagnets. The disadvantage with this however is that the electromagnet is comparatively heavy, which is basically problematic with aircraft applications, and that on account of the actuation, one can only ascertain in the emergency case or in sporadic intervals for test purposes, the moving component can jam to the extent that the magnet force is possibly no longer sufficient to move this. This represents a significant safety risk.

### SUMMARY OF THE INVENTION

Against this background, it is an object of the invention to provide an actuator which on the one hand is suitable for larger alternating voltages, consumes less current, is lightweight and operates reliably also after a longer period of not being actuated, i.e. produces a high actuation force.

According to the invention, this object is achieved by an actuator which in particular is suitable for opening a locking arrangement of an emergency oxygen container or a mask door in an aircraft, but also for other applications, comprising an opener of a shape memory alloy and of a resistance wire which is arranged thereon, is connected thereto in a heat-conducing manner and is connectable to a supply voltage. The actuator according to the invention is particularly advantageous for opening a locking arrangement of an emergency oxygen container or a mask door in an aircraft, but can however also be used for other applications in an advantageous manner, which are neither restricted to an aircraft nor to the opening procedure per se. Thus basically any and every actuation can be effected, e.g. the opening of an emergency door in a building, the opening of a flap of a car and much more.

The solution according to the invention is in particular particularly suitable for the application in an aircraft which is discussed here, since the resistance wire, given a suitable dimensioning, can be subjected directly to the alternating voltage which is available, without too high a current arising. Moreover, such an actuator can be manufactured inexpensively, simply and with only a little weight. The actuation forces of the actuator according to the invention are comparatively high, so that they also ensure a reliable actuation, in particular the opening, even after a longer period of not being actuated. The heating by way of the thermally conductive connection between the resistance wire and the opener is effected almost immediately, thus with a time delay which in practice is not noticeable.

Basically, the voltage can also be applied directly to the shape memory alloy. Since shape memory alloys have a low resistance, very high currents result with high voltages and these high currents could destroy the shape memory alloy. For this reason, the voltage would have to be transformed to a lower voltage, if it is to be applied directly to the shape memory alloy.

Advantageously, the resistance wire at least partly is wound around the opener, in order in this manner to achieve a rapid and intensive heating of the opener when subjecting the wire to current.

An opener is a component which is suitable for actuating a locking arrangement such that it is brought from a closed position into an opened position. Preferably, an opener is a component which is shaped in an elongate manner, so that a temperature change can effect a main extension of the opener in a single direction, which is to say in the longitudinal direction. Preferably, the cross section of the opener is circular, so that the risk of damage to the resistance wire is particularly low.

A locking arrangement is preferably configured to securely hold an emergency oxygen container and/or a mask door in a closed condition. A locking arrangement can then for example comprises a mechanical bar or an electromagnet for this. The opener is then preferably configured to be able to displace the mechanical bar into a position, in which it can no longer hold the emergency oxygen container or the mask door in a closed condition. If the locking arrangement comprises an electromagnet, the opener can be configured to disconnect this from an electric current.

Shape memory alloys are often called memory metals. This is due to the fact that they can assume an earlier shaping again despite a subsequent large deformation. The shape change is based on the temperature-dependent lattice transformation of two different crystal structures of a material. The shape memory alloy can have a one-way effect. The one-way effect is characterised by a one-off shape change on heating a sample which was previously pseudo-plastically deformed, for example in the martensitic condition. The shape memory alloy can also have an external two-way effect. The shape return on cooling a component and which is forced by way of a for example mechanical force acting externally, is indicated as an external two-way effect. This can be realized by a spring for example, which was tensioned during the heating. Preferably, the shape memory alloy has an intrinsic two-way effect, so that the opener is set up to be able to assume two different shapes at two different temperatures. The component has preferably gone through several thermo-mechanical treatment cycles, so that it can assume its defined shape again on cooling. Preferably, stress fields in the material were formed by way of this, which encourage the formation of certain martensite variants on cooling. Thus the trained shape for the cold condition preferably only represents a preferred shape of the martensite structure.

The shape memory alloy preferably comprises NiTi (nickel-titanium; nitinol) and/or CuZn (copper-zinc) and/or CuZnAl (copper-zinc-aluminium) and/or CuAlNi (copper-aluminium-nickel) and/or FeNiAl (iron-nickel-aluminium).

A resistance wire is a wire which has an electrical resistance. If current is led through the resistance, electrical power is converted into thermal power. The resistance wire can therefore also be indicated as a heating wire. It is possible to keep the mass to be heated small by way of the use of a resistance wire. The activation time can also be kept small by way of this.

Usefully, the opener is configured to change its length with changes of its temperature. By way of this, the opener can be applied in a particularly simple manner to open an emergency oxygen container and/or a mask door.

In one advantages design, a thermistor is connected in series before the resistance wire as a protection for this. The resistance wire is particularly protected by way of this and cannot heat to an unallowable extent on application of an electrical current.

Thermistors, PTC-resistors or PTC-thermistors are electrically conductive materials which are capable of conducting the current better at lower temperatures than at higher ones. Their electrical resistance increases with an increasing temperature. This type of resistors thus has a positive temperature coefficient. The thermistors can have a pure metal. Preferably, thermistor is manufactured of semi-conductive, polycrystalline ceramics, for example BaTiO₃ which in a certain temperature range build up a blocking layer at the grain boundaries.

A particularly advantageous design envisages the resistance wire comprising copper, nickel and manganese. The thermal power of the resistance wire can remain comparatively independent of the temperature of the resistance wire by way of this. A heating and thus desired defined length change of the opener can thus be set in a particularly accurate manner.

Particularly preferably, the resistance wire comprises 53 to 57% copper, 43 to 45% nickel and 0.5 to 1.2% manganese. A specific electrical resistance increasing particularly slowly with temperature and over a very large temperature range results by way of this. The released thermal power on application of an electric current remains particularly independent on the surrounding temperature by way of this.

In each case, one can envisage a distance between the windings of the resistance wire, in order to securely prevent a length change of the opener leading to a damage of the resistance wire. By way of this, the resistance wire can compensate length changes of the opener in a simple manner. Preferably, the width of the distance between two windings corresponds to at least the diameter of the resistance wire. Particularly preferably, the width of the distance is as large as double the diameter of the resistance wire.

In one advantageous embodiment, the opener and the resistance wire are at least partly received in a tube. By way of this, the opener can be led such that it is located in each case in a defined position at different temperatures. With a temperature increase and a lengthening of the opener resulting from this, the opener on account of this can extend in only two directions which are opposite to one another. An undesired sagging of the opener can be prevented. Moreover, it is this possible to ensure the functioning of the actuator even with unfavourable surrounding conditions, such as the installation in an environment, in which particles which can reach the resistance wire and which for example can tap current therefrom, are located. The opener can extend in only one direction if the tube is closed at one end.

Preferably, the wall of the tube is designed as thinly as possible. By way of this, one can prevent heat from being unnecessarily led away from the resistance wire. Moreover, such a design has a favourless effect on the weight of the actuator. Preferably, the thickness of the wall of the tube is smaller than the diameter of the resistance wire. Particularly preferably, the thickness of the wall corresponds to half the diameter of the resistance wire.

If the opener as well as the resistance wire are received in the tube, the wall of the tube advantageously consists of a material which has a low electrical conductivity and a low thermal conductivity. Preferably, the specific electric resistance of the tube lies above 10¹⁶Ω·mm²/m, particularly preferably above 10¹⁸Ω·mm²/m at 20 degrees Celsius. Preferably, the thermal conductivity of the tube lies below 1 W/(m*K), particularly preferably below 0.5 W(m*K) at 0 degrees Celsius.

In order to prevent the resistance wire becoming damaged with length changes of the opener, the opener at least partly can be received in a tube, and the resistance wire at least partly be wound around the tube. By way of this, the opener can also be led such that it is located in each case in a defined position at different temperatures. Moreover, a precise leading of the opener is possible by way of this. If the tube is provided between the opener and the resistance wire, the wall of the tube advantageously consists of a material which has a small electrical conductivity and a high thermal conductivity. Preferably, the specific electric resistance of the tube lies above 10¹⁶Ω·mm²/m, particularly preferably above 10¹⁸Ω·mm²/m at 20 degrees Celsius. Preferably, the thermal conductivity of the tube with this embodiment lies above 15 W/(m*K), particularly preferably above 200 W(m*K) at 0 degrees Celsius.

In one advantageous embodiment, the tube is a capillary. By way of this, it is possible to keep the mass of the tube very low, so that a rapid activation is possible with low energy consumption. A capillary is preferably a very fine, longitudinally extended cavity with a very small inner diameter.

In one advantageous embodiment, the actuator is arranged in a passenger service unit in an aircraft. By way of this, the actuator can be applied in a particularly effective manner for opening a mask door in an aircraft.

A passenger service unit is installed into large passenger aircraft in the pressure cabin above each passenger seat row. It contains for example reading lamps, loudspeakers, oxygen masks which fall out of an opening with a pressure drop, as well as suitably illuminating notice signals such as the fasten seatbelt signs. Often, a loudspeaker is located there for the audio instructions of the cabin crew.

Preferred embodiments of the invention are hereinafter explained in more detail by way of the attached drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a greatly simplified view showing a longitudinal section of an actuator and a bar of a mask door;

FIG. 2 is a view showing a longitudinal section of an actuator in a representation according to FIG. 1, with which the opener is received in a tube.

### DESCRIPTION OF THE PREFERRED EMBODIMENTS

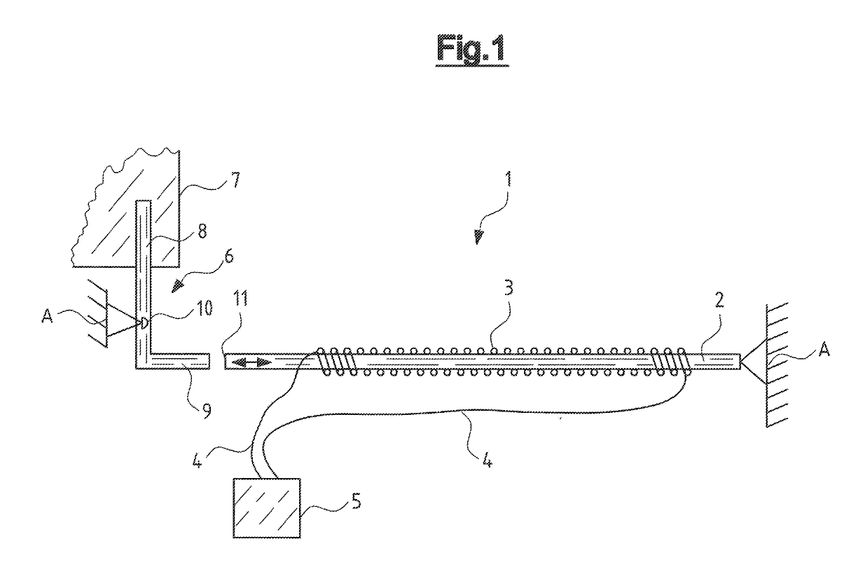

Referring to the drawings in particular, FIG. 1 shows a longitudinal section of an actuator 1 and a bar 6 of a mask door 7. The actuator 1 comprises an opener 2. The opener 2 is a rod with a circular cross section which consists of a memory shape alloy.

A resistance wire 3 is wound around a middle part of the opener 2 and is electrically insulated from the opener 2 via an insulating layer. Here, 280 windings of the resistance wire 3 are located on the opener 2. The resistance wire 3 is thereby wound around the opener 2 such that a distance is present between the individual windings. This distance corresponds roughly to the diameter of the resistance wire 3. The resistance wire 3 has about 55% copper, 44% nickel and 1% manganese.

At its ends, the resistance wire 3 is connected to connection leads 4. These connection leads 4 connect the resistance wire 3 to a supply voltage 5.

Apart from the actuator 1, a bar 6 and a part region of a mask door 7 is shown in FIG. 1. The bar 6 has an L-shape with a first limb 8 and with a second limb 9 and is rotatably mounted in a bearing 10. The bar 6 is arranged such that the first limb 8 lies in front of the mask door 7, and the second limb 9 is located in the direct vicinity of a first end 11 of the opener 2.

If current is led from the supply voltage 5 through the connection leads 4 and through the resistance wire 3, this is heated, since a part of the electric energy is converted into thermal energy by way of the electric resistance of the resistance wire 3. A part of the thermal energy is released to the opener 2 by way of thermal conduction, heat radiation and convection, since the resistance wire 3 bears directly on the opener 2. The opener 2 is heated by way of this.

Since the opener 2 is fixed on one side (bearing A) and changes its shape at high temperatures such that it increases its length, the end 11 of the opener 2 moves to the second limb 9 of the bar 6. If the end 11 presses against the second limb 9, a force on the bar 6 arises, whose line of action goes past the bearing 10, in which the bar 6 is rotatably received. A torque on the bar 6 arises by way of this, and the effect of this torque is that the bar 6 rotates in the clockwise direction about the bearing 10. By way of this, the first limb 8 of the bar 6 moves out of a region, in which it lies in front of the mask door 7, into a region in which it releases the mask door 7. By way of this, an opening of the mask door 7 is made possible by way of leading a current through the connection leads 4. In order to ensure that the mask door 7 opens when the bar 6 releases this, a compression spring which is not shown and which exerts a pressure onto the mask door 7, is provided on the side of the mask door 7 which is away from the bar.

Due to the fact that distances between the individual windings of the resistance wire 3 are provided, one prevents the resistance wire 3 from becoming damaged when the opener 2 extends.

A simpler, quicker, inexpensive and more robust actuator 1 for alternating voltages and one which consumes less energy and fulfils electric demands amongst other things with regard to the emission of interference and current distortions, is provided due to the fact that the opener 2 is heated indirectly by way of the resistance wire 3.

It would not be possible to heat the opener 2 in a direct manner without voltage transformation, since the supply voltage 5 supplies a high alternating voltage. This alternating voltage would have to be transformed to a lower voltage, which entails quite some effort, if this voltage were to be applied directly to the opener 2. The opener 2 has a very low resistance which with high voltages would lead to very high currents which would destroy the opener 2. Moreover, with a voltage transformation of an alternating input variable, an undesired current distortion can occur.

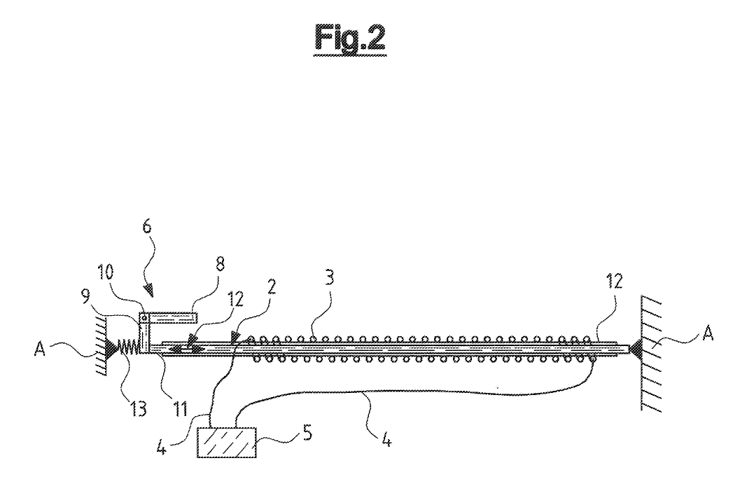

FIG. 2 shows a longitudinal section of an actuator 1, with which the opener 2 is received in a tube 12. The tube 12 consists of steel. It has a wall thickness of 0.1 mm. The resistance wire 3 has an electrical insulation layer formed by paint and is wound around the tube 12.

The opener 2 with a longitudinal change is additionally guided through the tube 12. Thus it is ensured that the opener 2 extends in a certain direction when it heats up. Moreover, one prevents the resistance wire 3 from being able to be damaged when the length of the opener 2 changes.

The wall thickness of the tube 12 is relatively thin, since the resistance wire 3 can be provided at a small distance to the opener 2 by way of this. Since the tube is of metal, a good thermal conduction between the resistance wire and the opener is effected. With the embodiment represented by way of FIG. 2, the opener by way of the bearing A is also prevented on one side from moving away from the bar 6 with an extension due to heating, and rather a length change in the direction of the second limb 9 of the bar 6 is effected.

With the embodiment represented by way of FIG. 2, a restoring spring 13 is yet provided, which ensures that the opener 2 returns back into its initial position with a subsequent cooling. The bar represented in FIG. 2 functionally corresponds to that represented by way of FIG. 1, even if the bar in FIG. 2 has a different shape and mounting.

While specific embodiments of the invention have been shown and described in detail to illustrate the application of the principles of the invention, it will be understood that the invention may be embodied otherwise without departing from such principles.

### APPENDIX

### List of Reference Numerals

1 actuator
2 opener
3 resistance wire
4 connection lead
5 supply voltage
6 bar
7 mask door
8 first limb
9 second limb
10 bearing
11 first end
12 tube
13 restoring spring
A bearing

What is claimed is:

1. A lock actuator comprising:
an opener of a shape memory alloy;
a resistance wire connected to said opener in a thermally conductive manner and connectable to a supply voltage.

2. An actuator according to claim 1, wherein said resistance wire at least partly is wound around said opener or along said opener.

3. An actuator according to claim 1, wherein said opener is configured to change length with changes of temperature.

4. An actuator according to claim 1, further comprising a thermistor connected in series with said resistance wire in front of said resistance wire.

5. An actuator according to claim 1, wherein said resistance wire comprises copper, nickel and manganese.

6. An actuator according to claim 1, wherein said resistance wire is at least partly wound around said opener or along said opener to provide a plurality of windings and a distance is present in each case between adjacent said windings of said resistance wire.

7. An actuator according to claim 1, further comprising a tube wherein said opener and said resistance wire are received at least partly in said tube.

8. An actuator according to claim 7, wherein said tube is a capillary

9. An actuator according to claim 1, further comprising a tube wherein said opener at least partly is received in said tube, and said resistance wire is wound at least partly around said tube.

10. An actuator according to claim 9, wherein said tube is a capillary.

11. An actuator according to claim 1, wherein the actuator is arranged in a passenger service unit in an aircraft.

12. An aircraft comprising:
a passenger service unit in an aircraft
an emergency oxygen container or mask container with a door, said emergency oxygen container or mask container being arranged in said passenger service unit in the aircraft;
a door lock actuator comprising an opener of a shape memory alloy and a resistance wire connected to said opener in a thermally conductive manner and connectable to a supply voltage.

13. An aircraft according to claim 12, wherein said resistance wire at least partly is wound around said opener or along said opener.

14. An aircraft according to claim 12, wherein said opener is configured to change length with changes of temperature.

15. An aircraft according to claim 12, further comprising a thermistor connected in series with said resistance wire in front of said resistance wire.

16. An aircraft according to claim 12, wherein said resistance wire comprises copper, nickel and manganese.

17. An aircraft according to claim 12, wherein said resistance wire is at least partly wound around said opener or along said opener to provide a plurality of windings and a distance is present in each case between adjacent said windings of said resistance wire.

18. An aircraft according to claim 12, further comprising a tube wherein said opener and said resistance wire are received at least partly in said tube.

19. An aircraft compartment door actuator comprising:
a compartment with a door;
a lock actuator comprising an opener of a shape memory alloy and a resistance wire connected to said opener in a thermally conductive manner and a supply voltage connected to said resistance wire.

20. An actuator according to claim 19, wherein:
said resistance wire at least partly is wound around said opener or along said opener; and
said opener is configured to change length with changes of temperature.
